(19) United States
(12) Patent Application Publication
(10) Pub. No.: US 2009/0128326 A1
(43) Pub. Date: May 21, 2009

(54) Using solar enery and wirless sensor network on the establishment of real-time monitoring system and method

(76) Inventor: Yao-Ming Hong, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/071,932

(22) Filed: Feb. 28, 2008

(30) Foreign Application Priority Data
Nov. 16, 2007 (TW) 96143451

(51) Int. Cl. H04Q 7/00

(52) U.S. Cl. 340/539.26

(57) ABSTRACT

This invention is to establish a real-time and self-supporting environmental monitoring system using wireless sensor network and solar energy. First, the precipitation volume and groundwater level of monitoring nodes are transported to the gateway by the multi-hop topology of wireless sensor network. Secondly, the gateway transmits the information to a base station via the GPRS or GSM. Finally, the monitoring data are transposed into an established database. The user can inquire about the real-time monitoring information via the internet, and so as to prevent the disaster and to reduce the damage in advance.

### BACKGROUND OF THE INVENTION

1. Field of the Invention

The present invention relates to a real-time and self-supporting environmental monitoring system, and more particularly, to a real-time and self-supporting environmental monitoring system using wireless sensor network and solar energy.

2. Description of the Prior Art

During the recent years, the technology and civilization of human society are highly developed to largely promote the convenience and enjoyment for people's daily life. On the other hand, the over utilization of the natural sources make the terrain features and hydrology of the earth change rapidly and so as to cause many environmental disasters including groundwater flow away, hillside slip or collapse, mudflows, stratum sink, water pollution of river and reservoir, etc. For example, there are one third of Taiwan's lands are hills or mountains, such that the typhoon or the torrential rain often brings heavy hill disaster.

Owing to the booming of the Internet, the real-time transportation ways nowadays include several wire communication networks, such as the Ethernet and several wireless communication networks, such as the Global Standard for Mobile Communications (GSM) and the General Packet Radio Services (GPRS) to proceed the distant data transmission.

Normally, the area that easily happens disaster and needs to do the environmental monitoring dwells rare people, and which area usually has no stable electrical power supply and the Local Area Network (LAN) to transmit the real-time environmental monitoring data. The wire communication network is very costly and difficult to build up. If the base stations widely spread in whole Taiwan are adopted, the wireless communication networks, such as the GPRS or the GSM to proceed the distant data transmission.

The Wireless Sensor Network (WSN) is a new technology, which may proceed the real-time data transmission for short distance and may let the far nodes away from the Gateway transmit the environmental monitoring data back to the relay station via the near nodes in an automatic topology way. The WSN has many advantages including high stability, small volume, multi-hop transmission, low power consumption, easy establishment, reduced electrical power supply equipments and being programmable, and so as to lower down the cost of real-time transmission and achieve the objects of high quality and low cost. Accordingly, the WSN is especially suitable for multi-point data transmission in small area.

On the other hand, because the oil is getting more and more shorted and expensive, the solar energy is free and never used out, and the semiconductor technology develops vastly and quickly, solar cells are increasingly used as the clean energy sources to apply in more and more fields. Furthermore, because it does not need to build up fixed transmission lines, the solar cells are very suitable to serve as the electrical power source of the environmental monitoring system. The volume buildup cost can be reduced if combining the WSN with the wireless communication networks, such as the GPRS or the GSM and wire communication networks, such as the Ethernet to fulfill the integration of the wireless communication for short and long distance.

Therefore, how to utilize the solar cells as the electrical power source to build up a wireless sensor network with high quality and accuracy for monitoring the real-time environmental information and forecasting the possible disasters including the hillside slip or collapse, and the mudflows to lower damage is truly an important issue.

### SUMMARY OF THE INVENTION

In order to solve the aforementioned problem, one object of the present invention is to provide a real-time and self-supporting environmental monitoring system and method using wireless sensor network and solar energy which use the solar energy module to serve as the electrical power source for the monitoring nodes and the relay station. The WSN has the advantages including small volume, easy establishment, low electrical power consumption, being capable of integrated to embedded equipment, being capable of wireless short distance transmission and being programmable. Furthermore, the monitor information of the WSN can be wirelessly transmitted to the base station via the GPRS or GSM, and then transpose into the established data base. The user may inquire the real-time monitor information through the Internet. As a result, the real-time and self-supporting environmental monitoring system and method using wireless sensor network and solar energy according to the present invention can be utilized for monitoring the rainfall and the underground water level of the hill, and it can inform the related organizations and residents and prevent the possible disasters and lower down the possible damage in time.

Because the real-time and self-supporting environmental monitoring system and method using wireless sensor network and solar energy of the present invention has the advantages including small volume, easy establishment, auto topology, high stability, being capable of integrated to embedded equipment, low electrical power consumption and being programmable, the equipments and cost of the electrical power supply and the communication transmission are largely reduced and the practicability for the technology realization is largely increased.

To achieve the objects mentioned above, one embodiment of the present invention is to provide a real-time and self-supporting environmental monitoring system using Wireless Sensor Network (WSN) and solar energy, which includes: a plurality of monitoring nodes to monitor a first environmental information, wherein the first environmental information is rainfall, underground water level, water pressure, permeation flow or PH value of water, and each of the monitoring nodes includes a first solar energy module to serve as an electrical power source; and a relay station to receive the monitor signals transmitted via a first wireless communication network from the monitoring nodes and then to relay and transmit, wherein the relay station includes a second solar energy module to serve as an electrical power source; and a base station to receive the monitor signals transmitted via a second wireless communication network from the relay station and to transpose the monitor signals into a monitor data to save.

To achieve the objects mentioned above, another embodiment of the present invention is to provide a real-time environmental monitoring method, which includes: providing a WSN, wherein the WSN includes a plurality of monitoring nodes to monitor a environmental information, the environmental information is rainfall, underground water level, water pressure, permeation flow or PH value of water, and each monitoring node includes a first solar energy module to serve as an electrical power source; providing a relay station, which includes a second solar energy module to serve as the electrical power source, to receive the monitor signals transmitted via a first wireless communication network from the monitoring nodes, and then to transmit; and providing a base station to receive the monitor signals transmitted via a second wireless communication network from the relay station, and to transpose the monitor signals into a monitor data to save.

### BRIEF DESCRIPTION OF THE DRAWINGS

The foregoing aspects and many of the accompanying advantages of this invention will become more readily appreciated as the same becomes better understood by reference to the following detailed description when taken in conjunction with the accompanying drawings, wherein:

FIG. 1 is a structural schematic diagram to demonstrate a real-time and self-supporting environmental monitoring system using wireless sensor network and solar energy according to one embodiment of the present invention;

FIG. 2 is a structural schematic diagram of a monitoring node according to one embodiment of the present invention;

FIG. 3 is a structural schematic diagram of a relay station according to one embodiment of the present invention;

FIG. 4 is a structural schematic diagram of a solar energy module according to one embodiment of the present invention;

FIG. 5 is a structural schematic diagram of a base station according to one embodiment of the present invention; and

FIG. 6 is a step diagram to demonstrate a real-time environmental monitoring method according to one embodiment of the present invention.

### DESCRIPTION OF THE PREFERRED EMBODIMENT

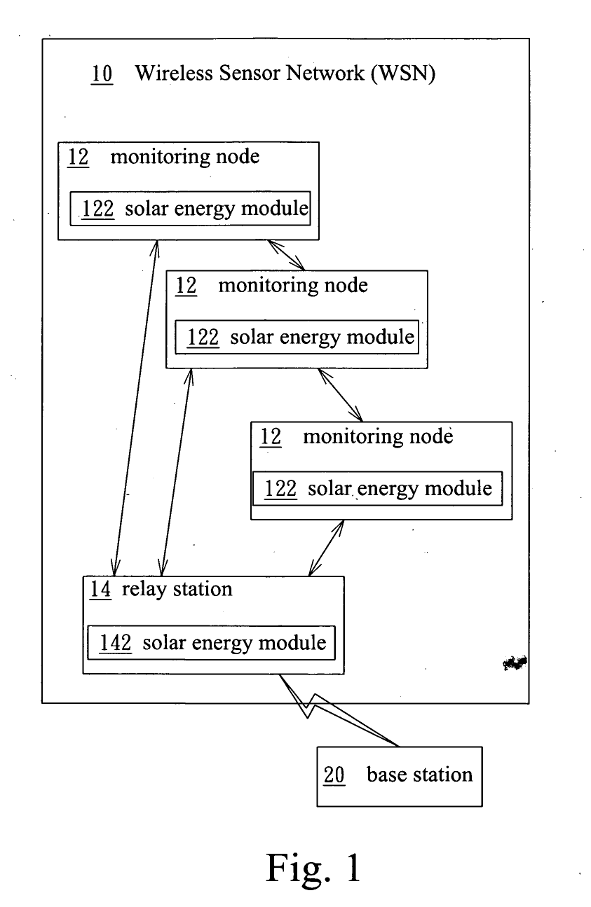

FIG. 1 is a structural schematic diagram to demonstrate a real-time and self-supporting environmental monitoring system using wireless sensor network and solar energy according to one embodiment of the present invention. The real-time and self-supporting environmental monitoring system includes: a WSN 10; and a base station 20. The WSN 10 includes: a plurality of monitoring nodes 12 to monitor a first environmental information, the first environmental information may be the rainfall, underground water level, water pressure, permeation flow or PH value of water, and each monitoring node 12 includes a solar energy module 122 to serve as an electrical power source; and a relay station 14, which includes a solar energy module 142 to serve as an electrical power source, to receive the monitor signals transmitted via a first wireless communication network from the monitoring nodes 12, and then to transmit. The base station 20 is used to receive the monitor signals transmitted via a second wireless communication network from the relay station 14, and to transpose the monitor signals into a monitor data to save.

In one embodiment, the first wireless communication network and the second wireless communication network may be a GPRS or a GSM.

Therefore, one feature of the real-time and self-supporting environmental monitoring system using wireless sensor network and solar energy according to the present invention is using a solar energy module to serve as an electrical power source for the monitoring nodes and the relay station, and transmitting monitor signals to base station via the GPRS or GSM. Moreover, the WSN has the advantages including small volume, easy establishment, low electrical power consumption, being capable of integrated to embedded equipment and being programmable. Accordingly, the WSN is very suitable for the environment needed to be intensely monitored, for example, a real-time and self-supporting monitoring system is very suitable for monitoring the rainfall and the underground water level of the hill.

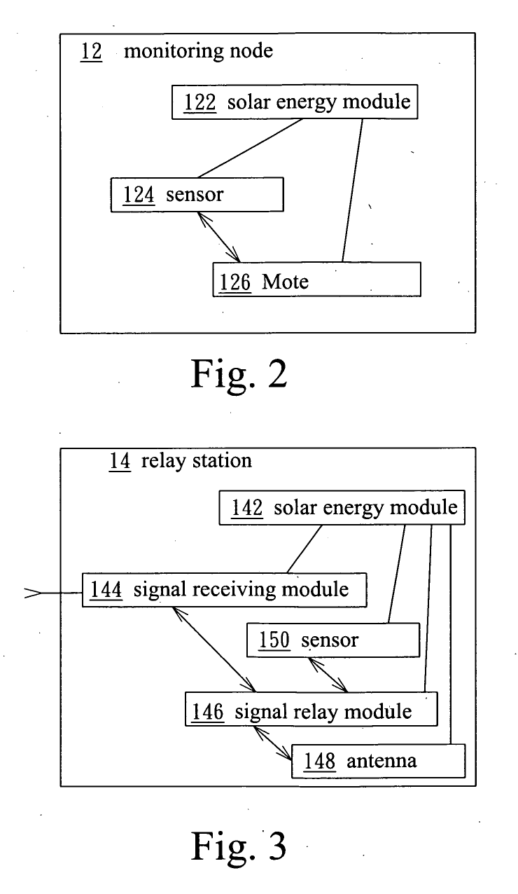

Please refer to FIG. 2 and FIG. 1, FIG. 2 is a structural schematic diagram of a monitoring node 12 according to one embodiment of the present invention. In one embodiment, each monitoring node 12 includes: a solar energy module 122 to serve as the electrical power source; a sensor 124 to monitor the aforementioned first environmental information; and a Mote 126 to control and process the first environmental information, and to transmit the monitor signals to the relay station 14 via the aforementioned first wireless communication network.

In one embodiment, the sensor 124 may be a rainfall measuring tube, an underground water level meter, a water pressure meter, a permeation flow meter or a PH value meter.

Please refer to FIG. 3 and FIG. 1, FIG. 3 is a structural schematic diagram of a relay station 14 according to one embodiment of the present invention. In one embodiment, the relay station 14 includes: a solar energy module 142 to serve as the electrical power source; a signal receiving module 144 to receive the monitor signal transmitted from the monitoring nodes 12; a signal relay module 146 to relay the monitor signals; and an antenna 148 to transmit the monitor signals to the base station 20 via the aforementioned second wireless communication network.

Please continuously refer to FIG. 3, in one embodiment, the relay station 14 further includes a sensor 150 to monitor a second environmental information and to send the second environmental information to the signal relay module 146. The second environmental information may be the rainfall, underground water level, water pressure, permeation flow or PH value of water.

In one embodiment, the sensor 150 may be a rainfall measuring tube, an underground water level meter, a water pressure meter, a permeation flow meter or a PH value meter.

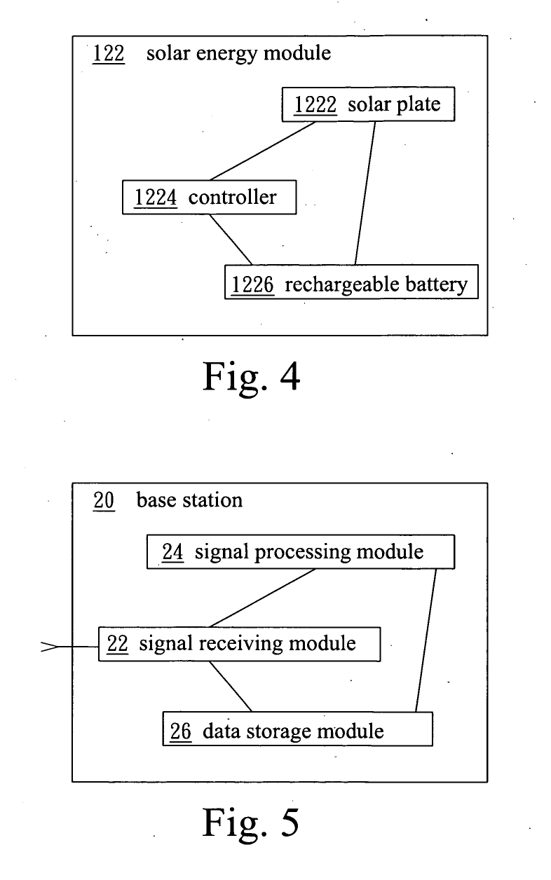

Please refer to FIG. 4 and FIG. 1, FIG. 4 is a structural schematic diagram of a solar energy module 122 according to one embodiment of the present invention. In one embodiment, the solar energy module 122 includes: a solar plate 1222 to receive sunlight and transform into electrical energy; a controller 1224 to control the solar energy module 122; and a rechargeable battery 1226 to store the electrical energy and serve as the electrical power source for the monitoring nodes 12.

Please continuously refer to FIG. 4, in one embodiment, the solar plate 1222 may be Si-based or compound-based, such as GaAs-based, InGaAs-based, CdTe-based, AlGaAs-based and Culn(Ga)Se2-based.

It is easy to be understood for the people having the ordinary knowledge that the solar energy module 142 may have the same structure with the solar energy module 122, so that it is not to further describe hereafter.

Please refer to FIG. 5 and FIG. 1, FIG. 5 is a structural schematic diagram of a base station 20 according to one embodiment of the present invention. In one embodiment, the base station 20 includes: a signal receiving module 22 to receive the monitor signals transmitted from the relay station 14; a signal processing module 24 to process the monitor signals into a monitor data; and a data storage module 26 to store the monitor data.

Please continuously refer to FIG. 5, in one embodiment, the data storage module 26 may be a Hard Disc (HD) or a Data Base (DB).

Therefore, one feature of the real-time and self-supporting environmental monitoring system using wireless sensor network and solar energy according to the present invention is that the monitor information of the WSN can be transmitted to the base station via the GPRS or GSM, and then transpose into the established data base. Accordingly, the user may inquire the real-time monitor information, such as the rainfall and underground water level of the hill, through the Internet to inform the related organizations and residents, and so as to prevent the possible disasters and lower down the possible damage.

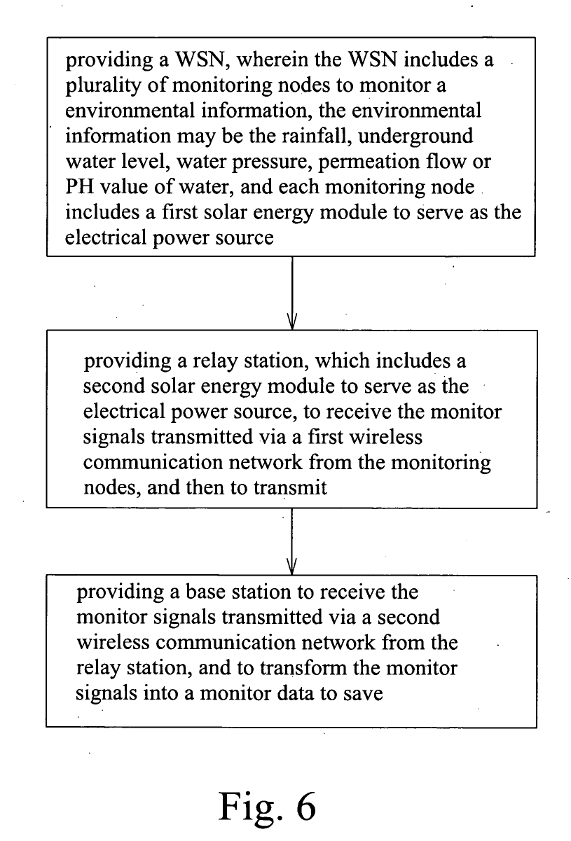

FIG. 6 is a step diagram to demonstrate a real-time environmental monitoring method according to one embodiment of the present invention. The steps include: providing a WSN, wherein the WSN includes a plurality of monitoring nodes to monitor a environmental information, the environmental information may be the rainfall, underground water level, water pressure, permeation flow or PH value of water, and each monitoring node includes a first solar energy module to serve as an electrical power source; providing a relay station, which includes a second solar energy module to serve as the electrical power source, to receive the monitor signals transmitted via a first wireless communication network from the monitoring nodes, and then to transmit; and providing a base station to receive the monitor signals transmitted via a second wireless communication network from the relay station, and to transpose the monitor signals into a monitor data to save.

To sum up, the real-time and self-supporting environmental monitoring system and method using wireless sensor network and solar energy according to the present invention use solar energy module to serve as the electrical power source for the monitoring nodes and the relay station. The WSN has the advantages including small volume, easy establishment, low electrical power consumption, being capable of integrated to embedded equipment, being capable of wireless short distance transmission and being programmable. Furthermore, the monitor information of the WSN can be wirelessly transmitted to the base station via the GPRS or GSM, and then transpose into the established data base. The user may inquire the real-time monitor information through the Internet. As a result, the real-time and self-supporting environmental monitoring system and method using wireless sensor network and solar energy according to the present invention largely reduce the equipments and cost of the electrical power supply and the communication transmission, and so as to increase the practicability for the technology realization.

To sum up, the real-time and self-supporting environmental monitoring system and method using wireless sensor network and solar energy according to the present invention is very suitable for the environment needed to be intensely monitored, for example, a real-time and self-supporting monitoring system and method using wireless sensor network and solar energy according to the present invention is very suitable for monitoring the rainfall and the underground water level of the hill, and it can inform the related organizations and residents and prevent the possible disasters and lower down the possible damage in time.

The foregoing descriptions of specific embodiments of the present invention have been presented for purposes of illustrations and description. They are not intended to be exclusive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to particular use contemplated. It is intended that the scope of the invention be defined by the Claims appended hereto and their equivalents.

What is claimed is:

1. A real-time and self-supporting environmental monitoring system using Wireless Sensor Network (WSN) and solar energy, comprising:
a plurality of monitoring nodes to monitor a first environmental information, wherein the first environmental information is rainfall, underground water level, water pressure, permeation flow or PH value of water, and each of the monitoring nodes comprises a first solar energy module to serve as an electrical power source;
a relay station to receive the monitor signals transmitted via a first wireless communication network from the monitoring nodes and then to relay and transmit, wherein the relay station comprises a second solar energy module to serve as an electrical power source; and
a base station to receive the monitor signals transmitted via a second wireless communication network from the relay station and to transpose the monitor signals into a monitor data to save.

2. The real-time and self-supporting environmental monitoring system using Wireless Sensor Network (WSN) and solar energy according to claim 1, wherein the first wireless communication network and the second wireless communication network may be a General Packet Radio Services (GPRS) or a Global Standard for Mobile Communications (GSM).

3. The real-time and self-supporting environmental monitoring system using Wireless Sensor Network (WSN) and solar energy according to claim 1, wherein each of the monitoring nodes further comprises:
a sensor to monitor the first environmental information; and
a Mote to control and process the first environmental information, and to transmit the monitor signals to the relay station via the first wireless communication network.

4. The real-time and self-supporting environmental monitoring system using Wireless Sensor Network (WSN) and solar energy according to claim 3, wherein the sensor is a rainfall measuring tube, an underground water level meter, a water pressure meter, a permeation flow meter or a PH value meter.

5. The real-time and self-supporting environmental monitoring system using Wireless Sensor Network (WSN) and solar energy according to claim 1, wherein relay station further comprises:
a signal receiving module to receive the monitor signals transmitted from the monitoring nodes;
a signal relay module to relay the monitor signals; and
an antenna to transmit the monitor signals to the base station via the second wireless communication network.

6. The real-time and self-supporting environmental monitoring system using Wireless Sensor Network (WSN) and solar energy according to claim 5, wherein the relay station further comprises sensor to monitor a second environmental information and to send the second environmental information to the signal relay module, and the second environmental information is rainfall, underground water level, water pressure, permeation flow or PH value of water.

7. The real-time and self-supporting environmental monitoring system using Wireless Sensor Network (WSN) and solar energy according to claim 6, wherein the sensor is a rainfall measuring tube, an underground water level meter, a water pressure meter, a permeation flow meter or a PH value meter.

8. The real-time and self-supporting environmental monitoring system using Wireless Sensor Network (WSN) and solar energy according to claim 1, wherein the first solar energy module comprises:
a solar plate to receive sunlight and transform into electrical energy;
a controller to control the solar energy module; and
a rechargeable battery to store the electrical energy and serve as the electrical power source for the monitoring nodes.

9. The real-time and self-supporting environmental monitoring system using Wireless Sensor Network (WSN) and solar energy according to claim 8, wherein the solar plate is Si-based.

10. The real-time and self-supporting environmental monitoring system using Wireless Sensor Network (WSN) and solar energy according to claim 8, wherein the solar plate is compound-based comprising GaAs-based, InGaAs-based, CdTe-based, AlGaAs-based and Culn(Ga)Se2-based.

11. The real-time and self-supporting environmental monitoring system using Wireless Sensor Network (WSN) and solar energy according to claim 1, wherein the second solar energy module comprising:
a solar plate to receive sunlight and transform into electrical energy;
a controller to control the solar energy module; and
a rechargeable battery to store the electrical energy and serve as the electrical power source for the monitoring nodes.

12. The real-time and self-supporting environmental monitoring system using Wireless Sensor Network (WSN) and solar energy according to claim 11, wherein the solar plate is Si-based.

13. The real-time and self-supporting environmental monitoring system using Wireless Sensor Network (WSN) and solar energy according to claim 11, wherein the solar plate is compound-based comprising GaAs-based, InGaAs-based, CdTe-based, AlGaAs-based and Culn(Ga)Se2-based.

14. The real-time and self-supporting environmental monitoring system using Wireless Sensor Network (WSN) and solar energy according to claim 1, wherein the base station comprising:
a signal receiving module to receive the monitor signals transmitted from the relay station;
a signal processing module to process the monitor signals into a monitor data; and
a data storage module to store the monitor data.

15. The real-time and self-supporting environmental monitoring system using Wireless Sensor Network (WSN) and solar energy according to claim 14, wherein the data storage module is a Hard Disc (HD) or a Data Base (DB).

16. A real-time environmental monitoring method, comprising:
providing a WSN, wherein the WSN comprises a plurality of monitoring nodes to monitor a environmental information, the environmental information is rainfall, underground water level, water pressure, permeation flow or PH value of water, and each monitoring node comprises a first solar energy module to serve as an electrical power source;
providing a relay station, which includes a second solar energy module to serve as the electrical power source, to receive the monitor signals transmitted via a first wireless communication network from the monitoring nodes, and then to transmit; and
providing a base station to receive the monitor signals transmitted via a second wireless communication network from the relay station, and to transpose the monitor signals into a monitor data to save.
